(19) United States
(12) Patent Application Publication
(10) Pub. No.: US 2012/0195455 A1
(43) Pub. Date: Aug. 2, 2012

(54) HEADPHONE

(76) Inventors: Yusuke Chiba, Akishima-shi (JP); Takafumi Asukagawa, Akishima-shi (JP); Masayuki Shibata, Akishima-shi (JP)

(21) Appl. No.: 13/500,051

(22) PCT Filed: Jun. 2, 2010
(86) PCT No.: PCT/JP2010/059350

§ 371 Date: Apr. 3, 2012

(30) Foreign Application Priority Data
Oct. 5, 2009 (JP) 2009 231915

(51) Int. Cl. H04R 1/10

(52) U.S. Cl. 381/374

(57) ABSTRACT

With an object to provide easy-to-assemble headphones with a stable waterproof performance, a headphone is formed of a mechanical attaching mechanism mechanically putting a front housing 5 and a rear housing 3 together, a waterproof mesh portion 11 having a first waterproof mesh 9 of a shape larger than a shape of a sound releasing hole 5c of the front housing 5 and disposed on an inner surface side of the front housing 5 so as to cover the sound releasing hole 5c, a first elastic ring 13 allowed to abut on an inner surface of the front housing 5 and a peripheral portion of the first waterproof mesh 9 of the waterproof mesh portion 11, and an inner housing 51 pressed by the rear housing 3 when the front housing 5 and the rear housing 3 are put together and in turn pressing the waterproof mesh portion 11 toward the inner surface of the front housing 5.

### BACKGROUND OF THE INVENTION

1. Field of the Invention

The present invention relates to a headphone having a housing and a driver unit installed in the housing.

2. Description of Related Art

Generally, a housing of headphones is not furnished with a waterproof function. Hence, when the headphones are dropped in water or get wet with rain, water penetrates inside of the housing and an acoustic performance of the driver unit becomes poor or the headphones become inoperable.

Given these circumstances, headphones furnished with a waterproof function as shown in Patent Documents 1 and 2 specified below have been proposed.

Each of these headphones has a separable housing and a driver unit installed in the housing. A sound releasing hole provided to the housing is closed with a waterproof cloth or the like to prevent penetration of water from the sound releasing hole.

### RELATED ART DOCUMENTS

### Patent Documents

Patent Document 1: JP-A-59-110299

Patent Document 2: JP-A-59-144297

### BRIEF SUMMARY OF THE INVENTION

### Problems to be Solved by the Invention

In headphones in the related art furnished with a waterproof function, however, a separable housing is assembled using an adhesive or by means of ultrasonic welding. Also, a waterproof cloth or the like having a waterproof property and used to close the sound releasing hole is also attached to the housing using an adhesive or by means of ultrasonic welding.

Accordingly, there is a problem that the waterproof property is deteriorated or the waterproof property is lost due to poor adhesion or poor welding. Also, there is another problem that application of an adhesive and an ultrasonic welding process makes assembling a time-consuming work.

Further, there is still another problem that even when a waterproof cloth or the like having a waterproof property and used to close the sound releasing hole is attached to the housing in a satisfactory manner, water still penetrates inside of the housing through the waterproof cloth or the like and a sufficient waterproof function cannot be obtained.

The invention was devised in view of the foregoing problems and has an object to provide easy-to-assemble headphones with a stable waterproof performance.

### Means for Solving the Problems

The present disclosure is directed to a headphone having:

a front housing provided with a sound releasing hole;

a rear housing forming, in cooperation with the front housing, a housing in which a driver unit is installed;

a mechanical attaching mechanism mechanically putting the front housing and the rear housing together;

a waterproof mesh portion having a first waterproof mesh of a shape larger than a shape of the sound releasing hole in the front housing and disposed on an inner surface side of the front housing so as to cover the sound releasing hole;

a first elastic ring disposed between the waterproof mesh portion and an inner surface of the front housing and allowed to abut on the inner surface of the front housing and a peripheral portion of the first waterproof mesh of the waterproof mesh portion; and

a pressing portion pressed by the rear housing when the front housing and the rear housing are put together and in turn pressing the waterproof mesh portion toward the inner surface of the front housing.

### Advantages of the Invention

According to the present disclosure, by merely incorporating the waterproof mesh portion, the first elastic ring, and the pressing portion into the housing and putting the front housing and the rear housing together using the mechanical attaching mechanism, the first waterproof mesh is pressed against the inner surface of the front housing via the first elastic ring, thereby preventing penetration of water from the sound releasing hole. Hence, because no adhesive is used, the waterproof performance is stabilized and assembling becomes easy.

### BRIEF DESCRIPTION OF DRAWINGS

FIG. 1 is an exploded cross section of a headphone according to an embodiment.

FIG. 2 is a view used to describe a bayonet locking mechanism that puts a front housing and a rear housing of FIG. 1 together.

FIG. 3 is an exploded perspective view of the headphone of FIG. 1.

FIG. 4 is a cross section of the headphone of FIG. 1.

### DETAILED DESCRIPTION OF THE INVENTION

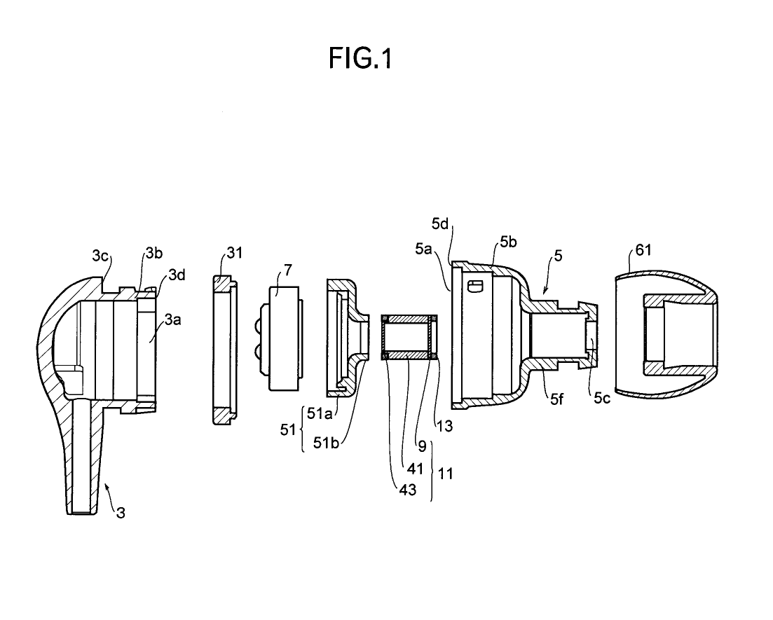

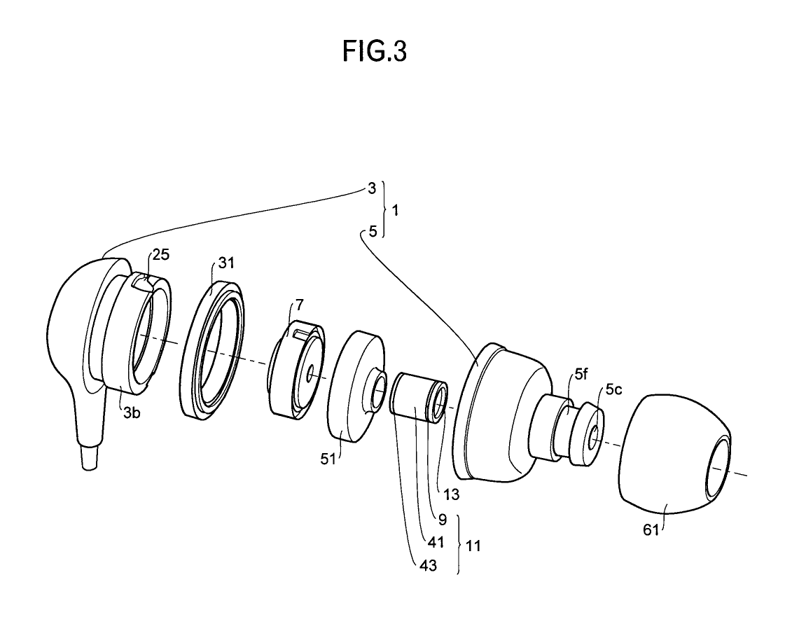

Firstly, an overall configuration of this embodiment will be described using FIG. 1 and FIG. 3. Referring to these drawings, a housing 1 is formed of a front housing 5 and a rear housing 3. A driver unit 7 generating a sound is installed in the housing 1.

The front housing 5 and the rear housing 3 are mechanically put together by a mechanical attaching mechanism described below.

A waterproof mesh portion 11, a first elastic ring 13, and a pressing portion are provided in the housing 1. The first elastic ring 13 is made of silicone rubber or the like. The first elastic ring 13 is disposed between the waterproof mesh portion 11 and an inner surface of the front housing 5 and allowed to abut on the inner surface of the front housing 5 and a peripheral portion of a first waterproof mesh 9 of the waterproof mesh portion 11. The pressing portion is pressed by the rear housing 3 when the front housing 5 and the rear housing 3 are put together and in turn presses the waterproof mesh portion 11 toward the inner surface of the front housing 5.

As is shown in FIG. 1, the front housing 5 has a first tube portion 5b provided with a first opening 5a on a side of one end portion. Also, the front housing 5 has an ear tip tube portion 5f provided continuously from the first tube portion 5b on a side of the other end portion and having a smaller diameter than the first tube portion 5b. The ear tip tube portion 5f is provided with a sound releasing hole 5c in a tip end surface.

The first waterproof mesh 9 is of a shape larger than a shape of the sound releasing hole 5c of the front housing 5 and disposed on the inner surface side of the ear tip tube portion 5f of the front housing 5 so as to cover the sound releasing hole 5c.

Meanwhile, the rear housing 3 is provided with a second opening 3a. Further, the rear housing 3 has a second tube portion 3b set to have a minor diameter larger than a major diameter of the driver unit 7. In this embodiment, the first tube portion 5b and the second tube portion 3b are formed so that the second tube portion 3b of the rear housing 3 is inserted into the first tube portion 5b of the front housing 5.

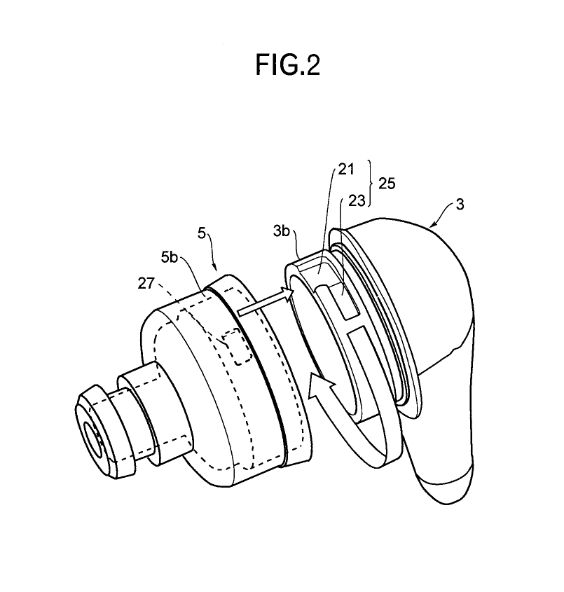

The mechanical attaching mechanism of this embodiment that puts the front housing 5 and the rear housing 3 together will now be described using FIG. 2. As is shown in FIG. 2, in this embodiment, a guide groove 25 is provided in an outer peripheral surface of the second tube portion 3b of the rear housing 3. The guide groove 25 is formed of an introductory portion 21 extending in an axial direction of the second tube portion 3b from the second opening 3a of the second tube portion 3b and a locking portion 23 provided continuously from the introductory portion 21 and extending in a circumferential direction of the second tube portion 3b. On the other hand, a slider 27 formed in a protruding shape to be movably engaged with the guide groove 25 is provided to the inner peripheral surface of the first tube portion 5b of the front housing 5. The guide groove 25 of the rear housing 3 and the slider 27 of the front housing 5 together form a bayonet locking mechanism that puts the front housing 5 and the rear housing 3 together. More specifically, the second tube portion 3b of the rear housing 3 is inserted into the first tube portion 5b of the front housing 5 so that the slider 27 is inserted into the introductory portion 21 of the guide groove 25. Subsequently, by rotating the front housing 5 and the rear housing 3 relatively with respect to each other so that the slider 27 moves into the locking portion 23, the front housing 5 and the rear housing 3 are put together.

As are shown in FIG. 1 and FIG. 3, a rising wall surface 3c is formed oppositely to an end face 5d of the first tube portion 5b of the front housing 5 on the outer peripheral surface of a base end portion of the second tube portion 3b of the rear housing 3 all along a circumferential region. Also, a second elastic ring 31 is disposed between the front housing 5 and the rear housing 3. The second elastic ring 31 is made of synthetic rubber or the like and pressed against by the end face 5d of the first tube portion 5b of the front housing 5 and the rising wall surface 3c of the second tube portion 3b of the rear housing 3 when the front housing 5 and the rear housing 3 are put together.

The waterproof mesh portion 11 of this embodiment is formed of a tube-like shaft 41 provided with holes in both end faces and disposed in the ear tip tube portion 5f of the front housing 5, the first waterproof mesh 9 provided so as to cover the hole in one end face of the shaft 41, and a second waterproof mesh 43 provided so as to cover the hole in the other end face of the shaft 41.

An inner housing 51 is disposed on the side of the rear housing 3 of the waterproof mesh portion 11. The inner housing 51 is formed of a large diameter portion 51a disposed in the first tube portion 5b of the front housing 5 and a small diameter portion 51b provided continuously from the large diameter portion 51a and disposed in the ear tip tube portion 5f. When the front housing 5 and the rear housing 3 are put together, the inner housing 51 functions as the pressing portion as the large diameter portion 51a is pressed by the end face 3d of the second tube portion 3b of the rear housing 3 and in turn the small diameter portion 51b presses the second waterproof mesh 43 of the waterproof mesh portion 11.

Further, an ear tip 61 made of synthetic rubber or the like is attached to the ear tip tube portion 5f of the front hosing 5. The ear tip 61 is inserted into an external auditory canal of an individual wearing the headphones.

An assembling method of the configuration described above will now be described using FIG. 1 and FIG. 3.

The second elastic ring 31 is preliminarily set to the second tube portion 3b of the rear housing 3. Subsequently, the driver unit 7, the inner housing 51, the waterproof mesh portion 11, and the first elastic ring 13 are set to the front housing 5. Then, the rear housing 3 and the front housing 5 are put together using the bayonet locking mechanism.

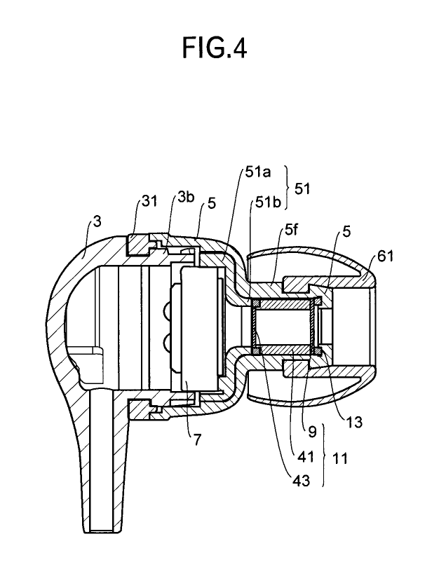

When the rear housing 3 and the front housing 5 are put together, as is shown in FIG. 4, the large diameter portion 51a of the inner housing 51 is pressed by the end face 3d of the second tube portion 3b of the rear housing 3 and in turn the small diameter portion 51b presses the second waterproof mesh 43 of the waterproof mesh portion 11. A force pressing the second waterproof mesh 43 is transmitted to the first waterproof mesh 9 via the shaft 41. The first waterproof mesh 9 is therefore pressed against the inner surface of the front housing 5 via the first elastic ring 13. It thus becomes possible to prevent penetration of water from the sound releasing hole 5c.

Further, as the front housing 5 and the rear housing 3 are put together, the end face 5d of the first tube portion 5b of the front housing 5 and the rising wall surface 3c of the second tube portion 3b of the rear housing 3 are pressed against the second elastic ring 31. A space between the front housing 5 and the rear housing 3 is thus waterproofed.

According to the configuration as above, the following advantages can be obtained.

(1) By merely incorporating the waterproof mesh portion 11, the first elastic ring 13, and the inner housing 51 as the pressing portion into the housing 1 and putting the front housing 5 and the rear housing 3 together using the bayonet locking mechanism as the mechanical attaching mechanism, the first waterproof mesh 9 is pressed against the inner surface of the front housing 5 via the first elastic ring 13. It thus becomes possible to prevent penetration of water from the sound releasing hole 5c. Hence, because no adhesive is used, the waterproof performance is stabilized and assembling becomes easy.

(2) By merely moving the slider 27 in the guide groove 25 from the introductory portion 21 to the locking portion 23, mechanical coupling of the front housing 5 and the rear housing 3 is completed. Hence, good operability is obtained.

(3) When the front housing 5 and the rear housing 3 are put together by the bayonet locking mechanism as the mechanical attaching mechanism, a space between the front housing 5 and the rear housing 3 is waterproofed by the second elastic ring 31 alone. Hence, the waterproof performance is stabilized and assembling becomes easy.

(4) By using two waterproof meshes, the first waterproof mesh 9 and the second waterproof mesh 43, the waterproof performance can be enhanced. Further, because the second waterproof mesh 43 can be also attached without using an adhesive, the waterproof performance is stabilized and the assembling becomes easy.

(5) Because the inner housing 51 is formed in a tube shape, the inner housing 51 becomes able to press the second waterproof mesh 43 of the waterproof mesh portion 11 homogeneously.

(6) In headphones in the related art, housings are put together by an adhesive or by means of ultrasonic welding. Hence, because the interior of the assembled housing is fully enclosed unless there is poor adhesion or poor welding, the driver unit or the like may possibly break due to a pressure change. On the contrary, in this embodiment, because the first elastic ring 13 and the second elastic ring 31 are used, it is thought that air permeability is secured through a fine clearing while a waterproof property is maintained. Hence, the driver unit or the like is prevented from breaking due to a pressure change.

(7) In comparison with general non-waterproof headphones, ESD (Electrostatic Discharge) is small. Also, a failure or breaking resulting from dust entering inside of the headphones hardly occurs.

It should be appreciated that the invention is not limited to the embodiment above. For example, modifications as follows are possible.

(1) In the embodiment above, the first tube portion 5b and the second tube portion 3b are formed so that the second tube portion 3b of the rear housing 3 is inserted into the first tube portion 5b of the front housing 5. However, it may be configured conversely, that is, a first tube portion and a second tube portion are formed so that the first tube portion of the front housing 5 is inserted into the second tube portion of the rear housing 3.

(2) The bayonet locking mechanism of the embodiment above is formed by providing the guide groove 25 in the outer peripheral surface of the second tube portion 3b of the rear housing 3 and providing the slider 27 to the inner peripheral surface of the first tube portion 5b of the front housing 5. However, it may be configured conversely in such a manner that a slider is provided to the outer peripheral surface of the second tube portion 3b of the rear housing 3 and a guide groove is provided in the inner peripheral surface of the first tube portion 5b of the front housing 5.

(3) A screw mechanism formed of a male screw and a female screw is also available as the mechanical attaching mechanism that puts the front housing 5 and the rear housing 3 together. For example, there is a screw mechanism formed of a male screw provided to the outer peripheral surface of the second tube portion 3b of the rear housing 3 and a female screw provided to the inner peripheral surface of the first tube portion 5b of the front housing 5 and threaded with the male screw.

### DESCRIPTION OF THE REFERENCE NUMERALS AND SIGNS

1: housing
3: rear housing
5: front housing
5c: sound releasing hole
9: first waterproof mesh
11: waterproof mesh portion
51: inner housing (pressing portion)

1. A headphone, characterized by having:
a front housing provided with a sound releasing hole;
a rear housing forming, in cooperation with the front housing, a housing in which a driver unit is installed;
a mechanical attaching mechanism mechanically putting the front housing and the rear housing together;
a waterproof mesh portion having a first waterproof mesh of a shape larger than a shape of the sound releasing hole in the front housing and disposed on an inner surface side of the front housing so as to cover the sound releasing hole;
a first elastic ring disposed between the waterproof mesh portion and an inner surface of the front housing and allowed to abut on the inner surface of the front housing and a peripheral portion of the first waterproof mesh of the waterproof mesh portion; and
a pressing portion pressed by the rear housing when the front housing and the rear housing are put together and in turn pressing the waterproof mesh portion toward the inner surface of the front housing.

2. The headphone according to claim 1, characterized in that:
the front housing has a first tube portion provided with a first opening;
the rear housing has a second tube portion provided with a second opening;
the first tube portion and the second tube portion are formed so that one tube portion, which is one of the first tube portion of the front housing and the second tube portion of the rear housing, is inserted into the other tube portion; and
the mechanical attaching mechanism is a bayonet locking mechanism formed by,
providing a guide groove formed of an introductory portion extending in an axial direction of the tube portion from the opening in the tube portion and a locking portion provided continuously from the introductory portion and extending in a circumferential direction of the tube portion in one of an inner peripheral surface of the one tube portion and an outer peripheral surface of the other tube portion, and
providing a slider movably engaged with the guide groove to the other one of the inner peripheral surface of the one tube portion and the outer peripheral surface of the other tube portion.

3. The headphone according to claim 2, characterized in that:
a rising wall surface is provided on an outer peripheral surface of the other tube portion, which is the other one of the first tube portion and the second tube portion inserted into the one tube portion, oppositely to an end face of the one tube portion all along a circumferential region; and
the headphone further has a second elastic ring that is pressed against by the end face of the one tube portion and the rising wall surface of the other tube portion when the front housing and the rear housing are put together.

4. The headphone according to claim 1, characterized in that:
the waterproof mesh portion is formed of,
a tube-like shaft provided with holes in both end faces,
the first waterproof mesh provided so as to cover a hole in one end face of the shaft, and
a second waterproof mesh provided so as to cover a hole in the other end face of the shaft.

5. The headphone according to claim 2, characterized in that:
the waterproof mesh portion is formed of,
a tube-like shaft provided with holes in both end faces,
the first waterproof mesh provided so as to cover a hole in one end face of the shaft, and
a second waterproof mesh provided so as to cover a hole in the other end face of the shaft.

6. The headphone according to claim 3, characterized in that:
the waterproof mesh portion is formed of,
a tube-like shaft provided with holes in both end faces,
the first waterproof mesh provided so as to cover a hole in one end face of the shaft, and
a second waterproof mesh provided so as to cover a hole in the other end face of the shaft.

7. The headphone according to claim 4, characterized in that:
the pressing portion is a tube-like inner housing that is pressed by the rear housing when the front housing and the rear housing are put together and in turn presses the second waterproof mesh of the waterproof mesh portion.

8. The headphone according to claim 5, characterized in that:
the pressing portion is a tube-like inner housing that is pressed by the rear housing when the front housing and the rear housing are put together and in turn presses the second waterproof mesh of the waterproof mesh portion.

9. The headphone according to claim 6, characterized in that:
the pressing portion is a tube-like inner housing that is pressed by the rear housing when the front housing and the rear housing are put together and in turn presses the second waterproof mesh of the waterproof mesh portion.
